(19) United States
(12) Patent Application Publication
(10) Pub. No.: US 2012/0062155 A1
(43) Pub. Date: Mar. 15, 2012

(54) Retarding Grid Cooling System and Control

(75) Inventors: Jian Wang, Ann Arbor, MI (US); Joanne Borchert, Peoria, IL (US); Benjamin Gottemoller, Peoria, IL (US); Bradley Bailey, Peoria, IL (US)

(73) Assignee: CATERPILLAR, INC., Peoria, IL (US)

(21) Appl. No.: 12/881,323

(22) Filed: Sep. 14, 2010

(51) Int. Cl. H02P 3/12

(52) U.S. Cl. 318/380; 318/471

(57) ABSTRACT

A cooling system (100) for a retarding grid (118) having a plurality of resistors (120) and insulators (122) is provided. The cooling system (100) may include a blower (130) configured to actively cool the retarding grid (118) and a controller (134) configured to selectively enable the blower (130). The controller (134) may enable the blower (130) based on thermal characteristics of the resistors (120) and the insulators (122) of the retarding grid (118). The thermal characteristics may include a current resistor temperature and a projected insulator temperature.

### TECHNICAL FIELD

The present disclosure relates generally to retarding assemblies, and more particularly, to systems and methods for cooling retarding grids.

### BACKGROUND

Electric drive systems for machines typically include a power circuit that selectively activates a motor at a desired torque. The motor is typically connected to a wheel or other traction device that operates to propel the machine. A hybrid drive system includes a prime mover, for example, an internal combustion engine, that drives a generator. The generator produces electrical power that is used to drive the motor. When the machine is propelled, mechanical power produced by the engine is converted to electrical power at the generator. This electrical power is often processed and/or conditioned before being supplied to the motor. The motor transforms the electrical power back into mechanical power to drive the wheels and propel the vehicle.

The machine is retarded in a mode of operation during which the operator desires to decelerate the machine. To retard the machine in this mode, the power from the engine is reduced. Typical machines also include brakes and some type of retarding mechanism to decelerate and/or stop the machine. As the machine decelerates, the momentum of the machine is transferred to the motor via rotation of the wheels. The motor acts as a generator to convert the kinetic energy of the machine to electrical power that is supplied to the drive system. This electrical energy can be dissipated through storage, waste, or any other form of consumption by the system in order to absorb the machine's kinetic energy.

A typical electrical retarding assembly or retarding grid includes a series of resistors and insulators, through which thermal energy is dissipated when electrical current passes through the resistors. Due to the size of the machine components and the magnitude of the momentum retarded, large amounts of thermal energy may be dissipated through the resistors and insulators, which significantly elevate the temperatures thereof. Accordingly, various solutions in the past have involved utilizing active cooling systems, such as forced convection by use of a fan or blower, to reduce the temperature of these devices. Known systems using fans or blowers include an electrically driven fan that creates an airflow passing over the resistors and insulators. Such motors are typically driven by an electrical signal that is directly or indirectly controlled by a control system of the machine.

Control systems for driving fans or blowers are known to those skilled in the art as a means to more efficiently dissipate heat from a retarding assembly. For example, U.S. Patent Application No. 2009/0293760 to Kumar, et al., discloses a drive system for a grid blower that controls a grid blower based on changes in the temperature of the grid resistors and various other vehicle operating parameters. While such drive systems account for changes in the temperature of the grid resistors, these systems do not account for changes in the temperature of grid insulators. Insulator temperatures of a retarding grid are susceptible to uneven distribution, or hotspots, as well as sudden increases in temperature when a blower is shut off, or overshoot. Insulator temperatures resulting from such hotspot and overshoot conditions can greatly exceed allowed thresholds and still be undetected by currently existing cooling controls and associated temperature monitors.

### SUMMARY OF THE DISCLOSURE

In one aspect of the present disclosure, a cooling system for a retarding grid having a plurality of resistors and insulators is provided. The cooling system includes a blower and a controller. The blower is configured to actively cool the retarding grid. The controller is configured to selectively enable the blower based on the thermal characteristics of the resistors and the insulators of the retarding grid. The thermal characteristics include a current resistor temperature and a projected insulator temperature.

In another aspect of the disclosure, an alternative embodiment of a cooling system for a retarding grid having a plurality of resistors and insulators is provided. The cooling system includes an interface circuit and a controller. The interface circuit is coupled to one or more switches. The switches are capable of selectively enabling the retarding grid and a blower. The controller is configured to communicate with the interface circuit. The controller is also configured to generate a control signal indicative of a desired level of heat dissipation as a function of the thermal characteristics of the resistors and the insulators. The thermal characteristics include current resistor temperature and projected insulator temperature.

In yet another aspect of the disclosure, a method of cooling a retarding assembly of a machine is provided. The machine includes a retarding grid and a blower. The retarding grid includes a plurality of resistors and insulators. The method determines current temperatures of the resistors and the insulators, determines projected temperatures of the insulators, determines a desired level of heat dissipation as a function of the current resistor temperature and the projected insulator temperature, and enables the retarding grid and the blower according to the desired level of heat dissipation.

### BRIEF DESCRIPTION OF THE DRAWINGS

FIG. 1 is a schematic view of an exemplary embodiment of a cooling system as applied to a retarding assembly of a machine;

FIG. 2 is a schematic view of another exemplary cooling system as applied to another retarding assembly;

FIG. 3 is a flow diagram of an exemplary method for cooling a retarding assembly; and

FIG. 4 is a diagrammatic view of an exemplary method of cooling a retarding assembly.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

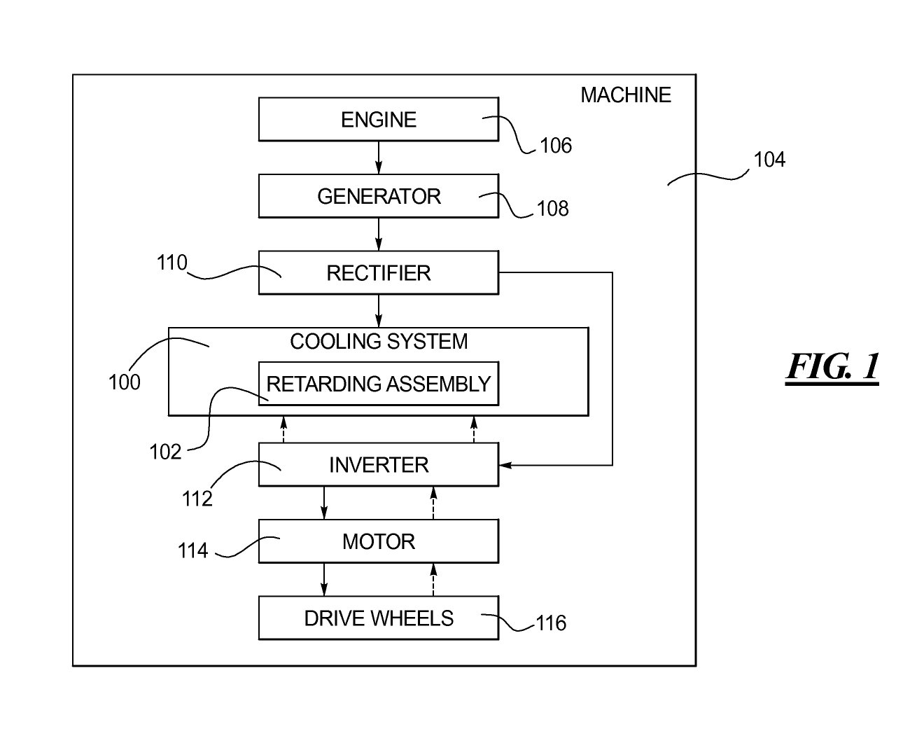

FIG. 1 schematically illustrates an exemplary cooling system 100 as applied to a retarding assembly 102 of an electric drive machine 104, such as an off-road truck, or the like. In addition to the retarding assembly 102, a typical electric drive machine 104 may include an engine 106, a generator 108, a rectifier circuit 110, an inverter circuit 112, a motor 114 and one or more final drive wheels 116. The retarding assembly 102 may be disposed at an output of the inverter circuit 112. The cooling system 100 may be integrated with the retarding assembly and also disposed at an output of the inverter circuit 112.

During acceleration or when the machine 104 is being propelled, power may be transferred from the engine 106 and toward the drive wheels 116, as indicated by solid arrows, to cause movement. Specifically, the engine 106 may produce an output torque to the generator 108, which may in turn convert the mechanical torque into electrical power. The electrical power may be generated in the form of alternating current (AC) power, which may be converted to direct current (DC) power by the rectifier circuit 110. The rectified DC power may be converted again to AC power by the inverter circuit 112. The AC power may then be used to drive the one or more motors 114 and the drive wheels 116, as is well known in the art.

During deceleration or when the motion of the machine 104 is to be retarded, power may be generated by the mechanical rotation at the drive wheels 116 and directed toward the retarding assembly 102, as indicated by dashed arrows. In particular, the kinetic energy of the moving machine 104 may be converted into rotational power at the drive wheels 116. Rotation of the drive wheels 116 may further rotate the motor 114 so as to generate electrical power, for example, in the form of AC power. The inverter circuit 112 may be a bridge inverter configured to convert the power supplied by the motor 114 into DC power. Dissipation of the DC power generated by the motor 114 may produce a counter-rotational torque at the drive wheels 116 to decelerate the machine 104. Such dissipation may be accomplished by passing the generated current provided by the inverter circuit 112 through a resistance, such as the retarding assembly 102 shown.

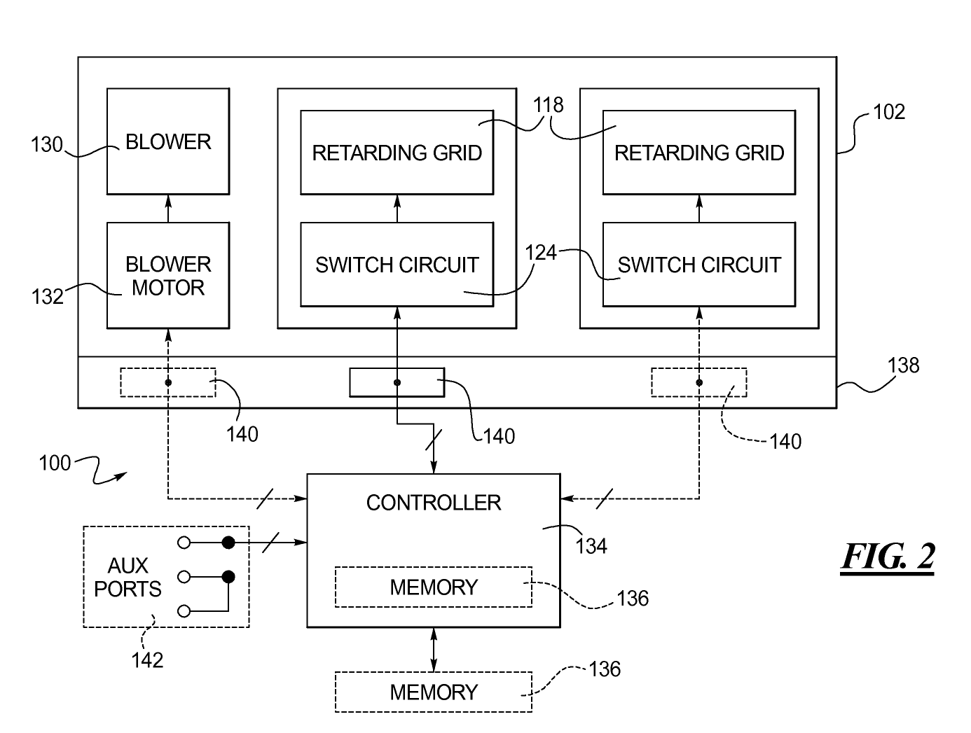

FIG. 2 shows one exemplary embodiment of a retarding assembly 102 that may serve to dissipate the power generated by the motor 114. As is well known in the art, the retarding assembly 102 may include at least a first retarding grid 118 of resistive elements, or resistors 120, as well as insulators 122. The resistors 120 may be configured to receive current from the inverter circuit 112 via one or more switches, or a switch circuit 124. The associated insulators 122 may serve to receive any heat being radiated from the resistors 120. When the switch circuit 124 is closed, the electrical power corresponding to the current generated by the motor 114 may at least partially pass through the first retarding grid 118 and be dissipated as heat. Excess electrical power may also be dissipated as heat by passing through an optional second retarding grid 126. The second retarding grid 126 may similarly include a second set of resistors 120 and insulators 122 that are configured to receive electrical power via a chopper circuit 128 and dissipate the power as heat. The chopper circuit 128 may serve to selectively route a portion of the developed electrical power through the second retarding grid 126.

In a retarding mode of operation, a significant amount of energy may be dissipated through the first retarding grid 118, which may translate into a significant amount of current being passed through the resistors 120. Dissipation of such energy may result in a substantial amount of heat being emitted at the retarding assembly 102. Accordingly, a blower 130, fan or any other suitable means for providing active cooling, may be provided to remove the excess heat and to prevent an overheating condition. The blower 130 may be driven by an inverter, blower motor 132, or the like, and configured to convectively cool at least the first retarding grid 118. While there may be a number of different alternatives available for driving the blower motor 132 and blower 130, in the particular embodiment of FIG. 2, the blower motor 132 may be configured to draw power from voltage-reduced locations across a portion of the first retarding grid 118 such that the blower 130 is enabled when voltage is applied to the first retarding grid 118, for example, during a retarding mode of operation.

Overall control of the retarding assembly 102 may be managed by a controller 134 that is embedded or integrated into the controls of the machine 104. The controller 134 may be implemented using one or more of a processor, a microprocessor, a controller, a microcontroller, an electronic control module (ECM), an electronic control unit (ECU), or any other suitable means for electronically controlling functionality of the machine 104. The controller 134 may be configured to operate according to a predetermined algorithm or set of instructions for controlling the retarding assembly 102 based on the various operating conditions of the machine 104. Such an algorithm or set of instructions may be read into or incorporated into a computer readable storage medium. For instance, the controller 134 may include memory 136 disposed thereon and/or as a component external to the controller 134. The memory 136 may take the form of, for example, a floppy disk, a hard disk, optical medium, a RAM, a PROM, an EPROM, or any other suitable computer-readable storage medium as is well known in the art.

The controller 134 may be electronically coupled to the retarding assembly 102 through an interface circuit 138 that provides one or more input and/or output ports 140. The controller 134 may also provide auxiliary inputs 142 through which the controller 134 may monitor various operating parameters of the machine 104. Through the ports 140, the controller 134 may be able to provide input to and enable or disable different components of the retarding assembly 102. The controller 134 may also be able to receive signals from and determine the status of the individual components of the retarding assembly 102 via the ports 140. Moreover, the controller 134 may be able to electronically communicate with one or more of the first retarding grid 118, switch circuit 124, second retarding grid 126, chopper circuit 128, blower 130, blower motor 132, and the like.

In alternative applications, the retarding assembly 102 may be provided as one kit, package or module combining, for example, the first retarding grid 118, switch circuit 124, blower 130, blower motor 132, and the like. In one such application, the controller 134 may be unable to communicate with each of the components of the retarding assembly 102, but rather, have communication access with, for example, only the switch circuit 124 associated with the first retarding grid 118. For example, the controller 134 of FIG. 2 may be able to selectively enable or disable the first retarding grid 118 and/or the blower 130 via a connection to the switch circuit 124. The controller 134 may further be able to selectively enable or disable the second retarding grid 126 via a connection to the chopper circuit 128.

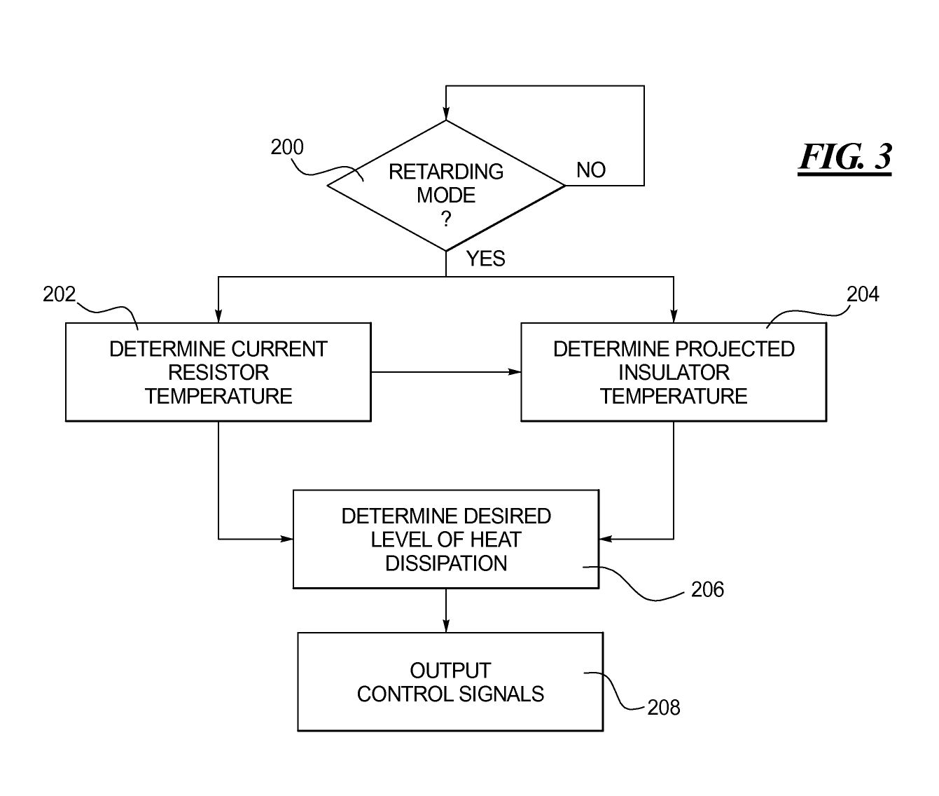

Referring now to the flow diagram of FIG. 3, an exemplary method for cooling a retarding assembly 102 is disclosed. The method disclosed may be implemented as an algorithm or a set of program codes by which the controller 134 is configured to operate. Based on the method of FIG. 3, the controller 134 may initially or continuously monitor various operating parameters to determine if the machine 104 is in a retarding mode in step 200. The controller 134 may also receive a retarding command through the auxiliary input 142 in response to displacement of a manual control by an operator of the machine 104. The retarding command may additionally or alternatively be generated from within the controller 134, or any other controller of the machine 104 that monitors or governs the speed of the machine 104, for example, a speed governor or a speed limiter.

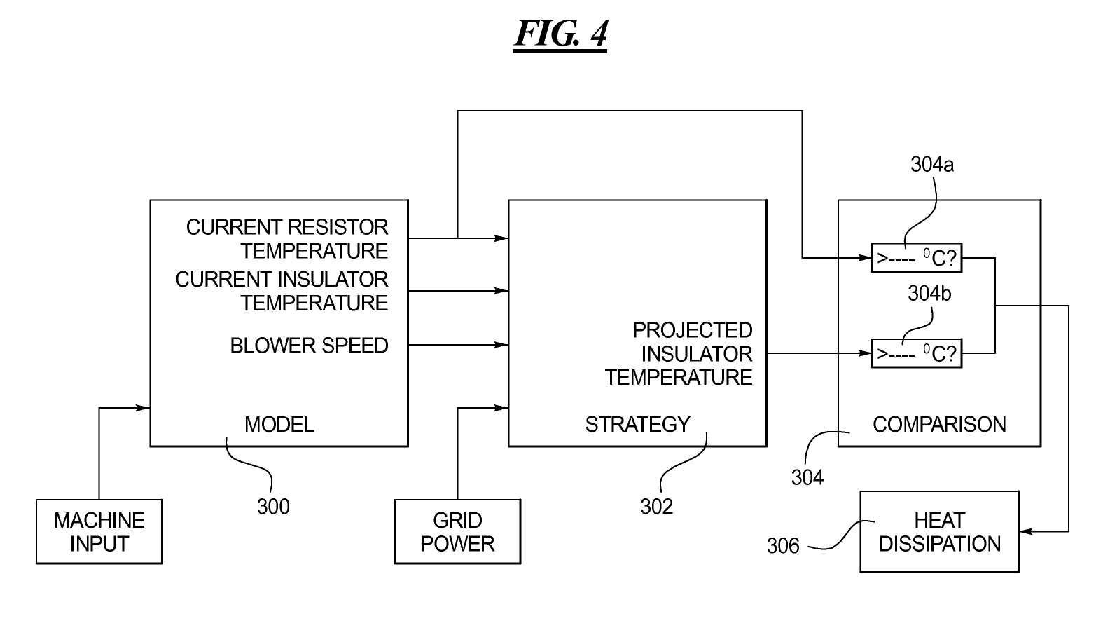

Once a retarding mode of operation is confirmed, the controller 134 may proceed to determine the current temperature of the resistors 120 and insulators 122 of at least the first retarding grid 118 in step 202. In many cases, the temperatures of the resistors 120 and insulators 122 may not be easily accessible or sensed by the controller 134. In such cases, the controller 134 may be preprogrammed with an algorithm corresponding to a thermal model 300, as schematically illustrated in FIG. 4. The thermal model 300 may provide a series of predetermined constraints and relationships which correlate the various operating conditions of the machine 104 with corresponding thermal characteristics of the resistors 120 and insulators 122. The thermal model 300 may monitor, for example, grid power, ambient temperature, atmospheric pressure, engine speed, status of the first retarding grid 118, and any other parameter relevant to the temperature of the retarding assembly 102. Using the thermal model 300 as a reference and based on one or more operating parameters detected at any particular moment, the controller 134 may predict a current resistor temperature as well as a current insulator temperature. Based on one or more operating parameters, the thermal model 300 may also estimate the speed of the blower 130, or the rate of convection being applied to the first retarding grid 118.

While the thermal model 300 may predict the current temperatures of the insulators 122 with some degree of accuracy, it may not be able to address the inconsistent thermal characteristics of insulators 122. For instance, the current insulator temperature estimated by the thermal model 300 may only reflect an average temperature of the insulators 122 of the first retarding grid 118. Such an average may not adequately account for particularly hot insulators 122, or hotspots, when there is an uneven insulator temperature distribution across the retarding grid 118. This average temperature may also overlook inadequate blower speed conditions and/or temperature overshoot conditions, wherein sudden increases in insulator temperature when the blower 130 is turned off.

Accordingly, as in step 204 of FIG. 3, the controller 134 may be configured to determine a more accurate estimate or projected temperature of the insulators 122 of at least the first retarding grid 118. More specifically, the controller 134 may apply an overshoot margin and/or a hotspot margin to the current insulator temperature provided by the thermal model 300 in step 202. The margins may be determined by an algorithm having a thermal management strategy 302, as schematically illustrated in FIG. 4. The thermal management strategy 302 may be preprogrammed with known relationships between the various operating conditions of the machine 104 and ideal insulator temperature limits. The thermal management strategy 302 may observe, for example, the current temperature of the resistors 120, the current temperature of the insulators 122, the estimated speed of the blower 130, and any other parameter relevant to insulator temperature. Using the preprogrammed relationships as a reference, the controller 134 may determine the magnitude of the margin to apply to the current insulator temperature. For example, the thermal management strategy 302 may configure the controller 134 to map the preprogrammed relationships to a series of scalar values corresponding to the magnitude of the overshoot and/or hotspot margins. The scalar values may then be applied to the current insulator temperature provided by the thermal model 300 to derive the projected insulator temperature.

Once the current resistor temperature and the projected insulator temperature have been determined, the controller 134 may determine the desired level of heat dissipation in step 206. As also shown in the comparison stage 304 of FIG. 4, the controller 134 may compare each of the current resistor temperature and the projected insulator temperature to respective preprogrammed thresholds. In the embodiment of FIG. 4, for example, the controller 134 may determine if the current temperature of the resistors 120 of the first retarding grid 118 exceeds a first predefined temperature threshold 304a, and if the projected temperature of the insulators 122 of the first retarding grid 118 exceeds a second predefined temperature threshold 304b. If none of the thresholds is exceeded, the controller 134 may exit the comparison stage 304 and return to monitoring the operating parameters of the machine 104 and the temperatures of the retarding assembly 102. If either threshold is exceeded, the controller 134 may proceed to a cooling mode of operation or cooling stage 306. In alternative embodiments, the controller 134 may employ different combinations of logic and different values of thresholds by which to proceed to the cooling stage 306.

If one or more of the thresholds are exceeded during the comparison stage 304, the controller 134 may advance to the cooling stage 306 and begin to output control signals indicative of the desired level of heat dissipation in step 208. Specifically, the controller 134 may output control signals to the switch circuit 124 corresponding to the first retarding grid 118 so as to enable the blower motor 132 and the blower 130 for cooling. Based on the magnitude of retarding required by the machine 104, the controller 134 may additionally enable the chopper circuit 128 corresponding to the second retarding grid 126. In enabling embodiments, the controller 134 may also be configured to output control signals directly to the blower 130 or blower motor 132.

### INDUSTRIAL APPLICABILITY

In general, the foregoing disclosure finds utility in various industrial applications, such as the construction and mining industry in providing more efficient cooling in work vehicles and/or machines, such as backhoe loaders, compactors, feller bunchers, forest machines, industrial loaders, skid steer loaders, wheel loaders, and the like. One exemplary machine suited to use of the disclosed systems and methods is a large off-highway truck, such as a dump truck. Exemplary off-highway trucks are commonly used in mines, construction sites and quarries. The off-highway trucks may have payload capabilities of 100 tons or more and travel at speeds of 40 miles per hour or more when fully loaded.

Such work trucks or machines must be able to negotiate steep inclines and operate in a variety of different environments. In such conditions, these machines must frequently enter into a retarding mode of operation for extended periods of time. Although effective dissipation of the heat during such frequent retarding modes of operation is critical, efficient use of power is also a key interest in such large machines. The systems and methods disclosed herein allow the control systems of such machines to more accurately predict and monitor the temperatures of the associated retarding assembly. By providing more accurate temperature predictions, the disclosed systems and methods minimize detrimental overheating conditions and allow more efficient cooling of the retarding assembly.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A cooling system for a retarding grid having a plurality of resistors and insulators, comprising:
a blower configured to actively cool the retarding grid; and
a controller configured to selectively enable the blower based on thermal characteristics of the resistors and the insulators, the thermal characteristics including a current resistor temperature and a projected insulator temperature.

2. The cooling system of claim 1, wherein the controller is preprogrammed with a thermal model and a thermal management strategy, the thermal model being configured to determine the current resistor temperature and a current insulator temperature, the thermal management strategy being configured to determine the projected insulator temperature.

3. The cooling system of claim 1, wherein the controller is configured to determine the projected insulator temperature based at least partially on blower speed, grid power and the current resistor temperature.

4. The cooling system of claim 1, wherein the projected insulator temperature incorporates an overshoot margin and a hotspot margin.

5. The cooling system of claim 1, wherein the controller is configured to selectively enable the blower if at least one of the current resistor temperature and the projected insulator temperature exceeds a predetermined threshold.

6. The cooling system of claim 1, wherein the controller is configured to selectively enable the retarding grid via a switch circuit and a second retarding grid via a chopper circuit, the second retarding grid having a second set of resistors and insulators.

7. A cooling system for a retarding grid having a plurality of resistors and insulators, comprising:
an interface circuit coupled to one or more switches, the switches capable of selectively enabling the retarding grid and a blower; and
a controller configured to communicate with the interface circuit, the controller being configured to generate a control signal indicative of a desired level of heat dissipation as a function of thermal characteristics of the resistors and the insulators, the thermal characteristics including current resistor temperature and projected insulator temperature.

8. The cooling system of claim 7, wherein the projected insulator temperature is based at least partially on estimated blower speed, grid power and an estimate of the current resistor temperature.

9. The cooling system of claim 7, wherein the control signal configures the interface circuit to enable the retarding grid and the blower according to the desired level of heat dissipation.

10. The cooling system of claim 7, wherein the blower is enabled if at least one of the current resistor temperature and the projected insulator temperature exceeds a predetermined threshold.

11. The cooling system of claim 7, wherein the projected insulator temperature incorporates one or more of an overshoot margin and a hotspot margin.

12. The cooling system of claim 7, wherein the controller is configured to determine the projected insulator temperature as a function of at least grid power, ambient temperature, atmospheric pressure, engine speed and estimated blower speed.

13. The cooling system of claim 7, wherein the controller is preprogrammed with a thermal model and a thermal management strategy, the thermal model being configured to determine the current resistor temperature and a current insulator temperature, the thermal management strategy being configured to determine the projected insulator temperature.

14. A method of cooling a retarding assembly of a machine having a retarding grid and a blower, the retarding grid having a plurality of resistors and insulators, the method comprising:
determining current temperatures of the resistors and the insulators;
determining projected temperatures of the insulators;
determining a desired level of heat dissipation as a function of the current resistor temperature and the projected insulator temperature; and
enabling the retarding grid and the blower according to the desired level of heat dissipation.

15. The method of claim 14, wherein the projected insulator temperature is based at least partially on estimated blower speed, grid power and the current resistor temperature.

16. The method of claim 14, wherein the retarding grid is enabled via a switch circuit and a second retarding grid is enabled via a chopper circuit.

17. The method of claim 14, wherein the blower is enabled if at least one of the current resistor temperature and the projected insulator temperature exceeds a predetermined threshold.

18. The method of claim 14, wherein the current temperatures of the resistors and the insulators are predicted using a preprogrammed thermal model, and the projected insulator temperature is determined using a preprogrammed thermal management strategy.

19. The method of claim 18, wherein the thermal management strategy applies one or more of an overshoot margin and a hotspot margin.

20. The method of claim 19, wherein the projected insulator temperature is a function of at least grid power, ambient temperature, atmospheric pressure, machine speed, and estimated blower speed.
